(19) United States
(12) Patent Application Publication
(10) Pub. No.: US 2025/0279233 A1
(43) Pub. Date: Sep. 4, 2025

(54) MULTILAYER COIL COMPONENT AND METHOD OF MANUFACTURING MULTILAYER COIL COMPONENT

(71) Applicant: Murata Manufacturing Co., Ltd., Kyoto-fu (JP)

(72) Inventor: Yasushi TAKEDA, Nagaokakyo-shi (JP)

(73) Assignee: Murata Manufacturing Co., Ltd., Kyoto-fu (JP)

(21) Appl. No.: 19/065,977

(22) Filed: Feb. 27, 2025

(30) Foreign Application Priority Data
Mar. 4, 2024 (JP) 2024-032025

(51) Int. Cl. H01F 17/00; H01F 27/32; H01F 41/04

(52) U.S. Cl. CPC H01F 17/0013; H01F 27/323; H01F 41/041; H01F 2017/002

(57) ABSTRACT

A multilayer coil component includes a multilayer body formed by laminating multiple insulating layers and having an inner electrode and first and second outer electrodes, each of which is electrically connected to the inner electrode. The inner electrode includes a coil formed by laminating multiple coil conductors together with the insulating layers, the coil conductors being electrically connected together, a first extended conductor connecting between the coil and the first outer electrode, and a second extended conductor connecting between the coil and the second outer electrode. The first and second extended conductors extend in a lamination direction in which the insulating layers are laminated. A coil conductor connected directly to the first extended conductor is a first coil conductor, and a coil conductor connected directly to the second extended conductor is a second coil conductor.

### CROSS-REFERENCE TO RELATED APPLICATION

This application claims benefit of priority to Japanese Patent Application No. 2024-032025, filed Mar. 4, 2024, the entire content of which is incorporated herein by reference.

### BACKGROUND

### Technical Field

The present disclosure relates to a multilayer coil component and a method of manufacturing the multilayer coil component.

### Background Art

For example, Japanese Unexamined Patent Application Publication No. 2002-15918 discloses a multilayer electronic component. The multilayer electronic component includes a coil formed therein by laminating coil conductors and insulating layers, the insulating layers being made of a magnetic substance or a non-magnetic substance. The multilayer electronic component also includes terminal electrodes at opposite ends of the coil in the lamination direction. At least one of the terminal electrodes is connected to the coil via a through-hole filled with a conductor material formed through at least one of the insulating layers and via an extended electrode that covers the end of the through-hole. In this multilayer electronic component, the area of the extended electrode is set to be three times or more of the cross-sectional area of the through-hole and one third or less of the inside area of the coil as the coil is viewed through the multilayer body in the lamination direction.

### SUMMARY

It is desirable to improve the connectivity between the inner electrode and the outer electrode at an extension portion of the multilayer inductor (i.e., the multilayer coil component).

The multilayer coil component described in Japanese Unexamined Patent Application Publication No. 2002-15918 is a multilayer coil component of a horizontal-winding electrode type in which the outer electrodes are extended out at opposite ends of the coil in the lamination direction of the insulating layers. In this type of the multilayer coil component, a transition portion (otherwise called an “extended-conductor connection portion”) between the coil conductor and the extended electrode (i.e., extended conductor) is bent, and wire breakage tends to occur at this bent portion.

The reason of this occurring is that when the conductor paste is sintered to form the coil conductor and the extended electrode, bubbles (or pores) are generated in the conductor paste, and the bubbles generated in the vicinity of the extended electrode are attracted outward. When the conductor paste is sintered, the extended electrode is not covered with the outer electrode and is exposed to the outside. Bubbles generated in the coil conductor near the exposed portion of the extended electrode are attracted outward, and then the bubbles tend to concentrate in the bent portion, in other words, in the transition portion or the extended-conductor connection portion between the coil conductor and the extended electrode. The concentrated bubbles cause wire breakage at this portion.

Accordingly, the present disclosure provides a multilayer coil component that can reduce the risk of wire breakage at the extended-conductor connection portion and also to provide a method of manufacturing the multilayer coil component.

According to the present disclosure, a multilayer coil component includes i) a multilayer body formed by laminating multiple insulating layers and having an inner electrode and ii) a first outer electrode and a second outer electrode each of which is electrically connected to the inner electrode. The inner electrode includes i) a coil formed by laminating multiple coil conductors together with the insulating layers, the coil conductors being electrically connected together, ii) a first extended conductor connecting between the coil and the first outer electrode, and iii) a second extended conductor connecting between the coil and the second outer electrode. The first extended conductor and the second extended conductor extend in a lamination direction in which the insulating layers are laminated. Among the coil conductors, a coil conductor connected directly to the first extended conductor is a first coil conductor, and a coil conductor connected directly to the second extended conductor is a second coil conductor. A pore area ratio of each of the first extended conductor, the second extended conductor, the first coil conductor, and the second coil conductor is 1.00% or more and 11.00% or less (i.e., from 1.00% to 11.00%).

In a method of manufacturing a multilayer coil component according to a first embodiment of the present disclosure, the multilayer coil component includes i) a multilayer body formed by laminating multiple insulating layers and having an inner electrode, and ii) a first outer electrode and a second outer electrode each of which is electrically connected to the inner electrode. The inner electrode includes i) a coil formed by laminating multiple coil conductors together with the insulating layers, the coil conductors being electrically connected together, ii) a first extended conductor connecting between the coil and the first outer electrode, and iii) a second extended conductor connecting between the coil and the second outer electrode. The first extended conductor and the second extended conductor extend in a lamination direction in which the insulating layers are laminated. The method of manufacturing a multilayer coil component includes i) a step of preparing ceramic green sheets containing a ceramic material, ii) a printing step of forming conductor paste layers by applying a conductor paste onto the ceramic green sheets, the conductor paste layers corresponding to the coil conductors, the first extended conductor, and/or the second extended conductor, iii) a step of preparing an unsintered multilayer body containing an unsintered coil by laminating the ceramic green sheets with the conductor paste layers formed thereon, and iv) a step of sintering the unsintered multilayer body to obtain a multilayer body. Among the coil conductors, a coil conductor connected directly to the first extended conductor is a first coil conductor, and a coil conductor connected directly to the second extended conductor is a second coil conductor. A PVC of the conductor paste for forming the first extended conductor, the second extended conductor, the first coil conductor, and the second coil conductor is 45.00% or more and 55.00% or less (i.e., from 45.00% to 55.00%).

In a method of manufacturing a multilayer coil component according to a second embodiment of the present disclosure, the multilayer coil component includes i) a multilayer body formed by laminating multiple insulating layers and having an inner electrode, and ii) a first outer electrode and a second outer electrode each of which is electrically connected to the inner electrode. The inner electrode includes i) a coil formed by laminating multiple coil conductors together with the insulating layers, the coil conductors being electrically connected together, ii) a first extended conductor connecting between the coil and the first outer electrode, and iii) a second extended conductor connecting between the coil and the second outer electrode. The first extended conductor and the second extended conductor extend in a lamination direction in which the insulating layers are laminated. The method of manufacturing the multilayer coil component includes i) a step of preparing ceramic green sheets containing a ceramic material, ii) a printing step of forming conductor paste layers by applying a conductor paste onto the ceramic green sheets, the conductor paste layers corresponding to the coil conductors, the first extended conductor, and/or the second extended conductor, iii) a step of preparing an unsintered multilayer body containing an unsintered coil by laminating the ceramic green sheets with the conductor paste layers formed thereon, and iv) a step of sintering the unsintered multilayer body to obtain a multilayer body. Among the coil conductors, a coil conductor connected directly to the first extended conductor is a first coil conductor, and a coil conductor connected directly to the second extended conductor is a second coil conductor. The conductor paste for forming the first extended conductor, the second extended conductor, the first coil conductor, and the second coil conductor contains a metal powder produced using a method other than a water atomization method, and the conductor paste for forming at least one of the coil conductors other than the first coil conductor and the second coil conductor contains a metal powder produced using the water atomization method.

According to the present disclosure, a multilayer coil component that can reduce the risk of wire breakage at the extended-conductor connection portion and a method of manufacturing the multilayer coil component can be provided.

### BRIEF DESCRIPTION OF THE DRAWINGS

FIG. 1 is a perspective view schematically illustrating an example of a multilayer coil component according to a first embodiment of the present disclosure;

FIG. 2 is an exploded perspective view schematically illustrating an example of a multilayer body included in the multilayer coil component of FIG. 1;

FIG. 3 is a side view schematically illustrating an example of an internal structure of the multilayer body included in the multilayer coil component of FIG. 1;

FIG. 4 is a cross-sectional view schematically illustrating an example cross section of the multilayer coil component taken along line A1-A1 in FIG. 1;

FIG. 5 is a cross-sectional view schematically illustrating an example cross section of the multilayer coil component taken along line A2-A2 in FIG. 1;

FIG. 6 is a cross-sectional view schematically illustrating an example of a multilayer coil component that does not satisfy the features of the present disclosure;

FIG. 7 is an exploded perspective view schematically illustrating a multilayer body of an example multilayer coil component according to a second embodiment of the present disclosure;

FIG. 8 is a side view schematically illustrating a state of pores of an inner electrode included in the multilayer coil component having the multilayer body of FIG. 7;

FIG. 9 is a perspective view schematically illustrating an example of a multilayer coil component according to a third embodiment of the present disclosure;

FIG. 10 is an exploded perspective view schematically illustrating an example of a multilayer body included in the multilayer coil component of FIG. 9; and

FIG. 11 is a cross-sectional view schematically illustrating an example cross section of the multilayer coil component taken along line A3-A3 in FIG. 9.

### DETAILED DESCRIPTION

A multilayer coil component and a method of manufacturing the multilayer coil component will be described in accordance with the present disclosure. Note that the configurations described herein are not intended to limit the present disclosure and can be modified appropriately within the scope of the present disclosure. In addition, a combination of individual preferred configurations described herein is deemed to fall within the scope of the present disclosure.

Drawings to be referred to below are schematic illustrations, and accordingly dimensions, aspect ratios, or the like may be different from those of an actual product. In the drawings, the same or equivalent portions are denoted by the same reference signs. In each drawing, the same elements are denoted by the same reference signs, thereby eliminating duplicated descriptions of such elements.

In the present specification, terms used to describe a relationship between elements (for example, “parallel”, “orthogonal”, or the like) or used to describe the shape of an element are not only used in their strict senses but also used in their substantially equivalent senses so as to allow for a certain range, for example, a several-percent difference.

Note that the embodiments described herein are examples and configurations described in different embodiments can be partially replaced or combined with one another. In embodiments to be described after the first embodiment, the description will focus on differences, and the description of the same elements as those of the first embodiment will be omitted. The description of the same advantageous effects obtained by the same configuration in different embodiments will not be repeated.

### Multilayer Coil Component

According to the present disclosure, a multilayer coil component includes i) a multilayer body formed by laminating multiple insulating layers and having an inner electrode and ii) a first outer electrode and a second outer electrode each of which is electrically connected to the inner electrode. The inner electrode includes i) a coil formed by laminating multiple coil conductors together with the insulating layers, the coil conductors being electrically connected together, ii) a first extended conductor connecting between the coil and the first outer electrode, and iii) a second extended conductor connecting between the coil and the second outer electrode. The first extended conductor and the second extended conductor extend in a lamination direction in which the insulating layers are laminated. Among the coil conductors, a coil conductor connected directly to the first extended conductor is a first coil conductor, and a coil conductor connected directly to the second extended conductor is a second coil conductor. A pore area ratio of each of the first extended conductor, the second extended conductor, the first coil conductor, and the second coil conductor is 1.00% or more and 11.00% or less (i.e., from 1.00% to 11.00%).

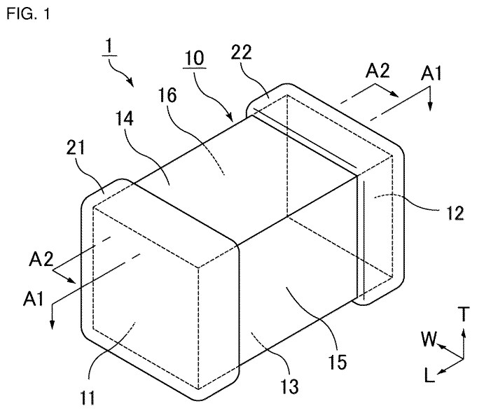

FIG. 1 is a perspective view schematically illustrating an example of a multilayer coil component according to a first embodiment of the present disclosure.

A multilayer coil component 1 illustrated in FIG. 1 includes a multilayer body (main body) 10, a first outer electrode 21, and a second outer electrode 22. The first outer electrode 21 and the second outer electrode 22 are formed on outer surfaces of the multilayer body 10. The multilayer body 10 is shaped like a cuboid having six faces. The multilayer body 10 is formed by laminating multiple insulating layers in the lamination direction. The multilayer body 10 includes an inner electrode formed of first and second extended conductors and a coil. The structure of the multilayer body 10 will be described later again. The first outer electrode 21 is electrically connected to the coil via a first extended conductor, and the second outer electrode 22 is electrically connected to the coil via a second extended conductor.

In the present specification, the length direction, the height direction, and the width direction of the multilayer coil component and of the multilayer body are denoted by L, T, and W, respectively, as illustrated in FIG. 1. The length direction L, the height direction T, and the width direction W orthogonally intersect each other. The length direction L extends parallel to the lamination direction.

As illustrated in FIG. 1, the multilayer body 10 includes a first end surface 11 and a second end surface 12 that are opposite to each other in the length direction L. The multilayer body 10 also includes a first principal surface 13 and a second principal surface 14 that are opposite to each other in the height direction T that orthogonally intersects the length direction L. The multilayer body 10 also includes a first side surface 15 and a second side surface 16 that are opposite to each other in the width direction W that orthogonally intersects the length direction L and the height direction T.

The edges and vertices of the multilayer body 10 are preferably rounded although not illustrated in FIG. 1. The vertices are portions at which three surfaces of the multilayer body intersect, and the edges are portions at which two surfaces of the multilayer body intersect.

For example, as illustrated in FIG. 1, the first outer electrode 21 covers the first end surface 11 of the multilayer body 10 entirely and also covers a part of the first principal surface 13, a part of the second principal surface 14, a part of the first side surface 15, and a part of the second side surface 16, these parts being continuous to the first end surface 11.

For example, as illustrated in FIG. 1, the second outer electrode 22 covers the second end surface 12 of the multilayer body 10 entirely and also covers a part of the first principal surface 13, a part of the second principal surface 14, a part of the first side surface 15, and a part of the second side surface 16, these parts being continuous to the second end surface 12.

When the multilayer coil component 1 having the first outer electrode 21 and the second outer electrode 22 as described above is mounted onto a circuit board, the mounting surface can be either the first principal surface 13, the second principal surface 14, the first side surface 15, or the second side surface 16 of the multilayer body 10.

It is sufficient, however, that the first outer electrode 21 be present only from part of the first end surface 11 to a mounting surface of the multilayer body 10.

Similarly, it is sufficient that the second outer electrode 22 be present only from part of the second end surface 12 to a mounting surface of the multilayer body 10.

Each of the first outer electrode 21 and the second outer electrode 22 has a single layer structure or a multilayer structure.

In the case of the first and second outer electrodes 21 and 22 each having the single layer structure, the material of these electrodes is, for example, Ag, Au, Cu, Pd, Ni, or Al, or an alloy containing at least one of these.

In the case of the first and second outer electrodes 21 and 22 each having the multilayer structure, each electrode includes, for example, a base layer containing Ag, a Ni cover layer, and a Sn cover layer from the surface of the multilayer body 10.

The size of the multilayer coil component of the present disclosure is not specifically limited but may be so-called “0603 size”, “0402 size”, or “1005 size”.

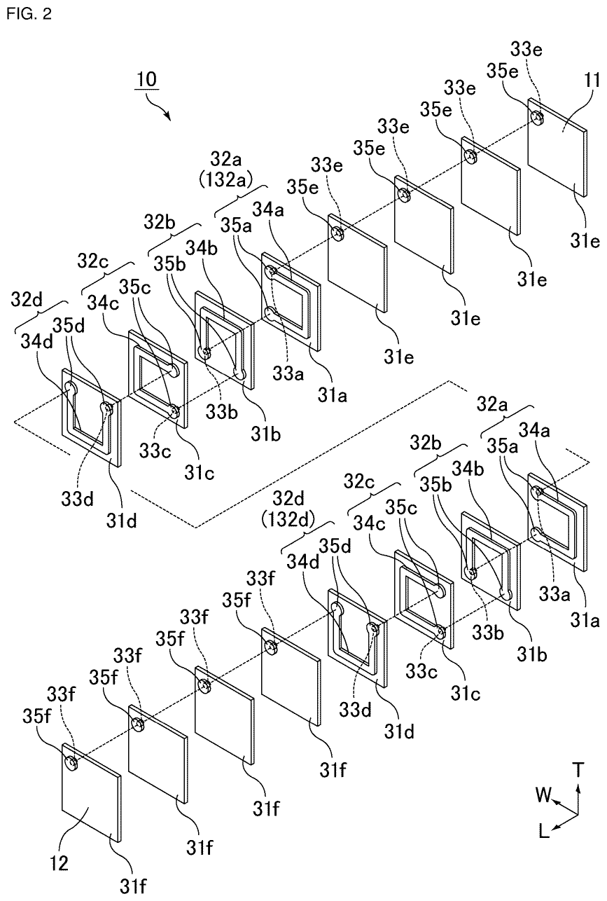

FIG. 2 is an exploded perspective view schematically illustrating an example of a multilayer body included in the multilayer coil component of FIG. 1.

As illustrated in FIG. 2, the multilayer body 10 is formed by laminating multiple insulating layers 31a, 31b, 31c, 31d, 31e, and 31f in the lamination direction (i.e., in the length direction L in this case) from the first end surface 11 toward the second end surface 12 of the multilayer body 10. The insulating layers 31a, 31b, 31c, 31d, 31e, and 31f may be collectively referred to as insulating layers 31.

Note that in this specification, the lamination direction is the direction in which multiple insulating layers of the multilayer body are stacked.

In FIG. 2, the insulating layer 31e is disposed at the bottom of the multilayer body 10 in the lamination direction (i.e., at the first end surface 11), whereas the insulating layer 31f is disposed at the top of the multilayer body 10 in the lamination direction (i.e., at the second end surface 12).

The insulating layers 31 are made of, for example, a magnetic material, such as a ferrite material.

The insulating layers 31a, 31b, 31c, and 31d include respective coil conductors 32a, 32b, 32c, and 32d and respective via conductors 33a, 33b, 33c, and 33d formed therein. An insulating layer 31e includes a via conductor 33e and a land 35e formed therein. An insulating layer 31f includes a via conductor 33f and a land 35f formed therein. A single insulating layer 31e or multiple insulating layers 31e may be provided. Similarly, a single insulating layer 31f or multiple insulating layers 31f may be provided. The coil conductors 32a, 32b, 32c, and 32d may be collectively referred to as coil conductors 32.

The coil conductors 32a, 32b, 32c, and 32d are formed on respective principal surfaces of insulating layers 31a, 31b, 31c, and 31d and are laminated together with the insulating layers 31a, 31b, 31c, 31d, 31e, and 31f. In FIG. 2, each coil conductor 32 forms a three-quarter portion of one turn of coil. Four insulating layers 31 consisting of the insulating layers 31a, 31b, 31c, and 31d are laminated in this order to form one unit (i.e., to form three turns of coil), and multiple units are further laminated one after another.

The coil conductors 32a, 32b, 32c, and 32d include respective loop portions, in other words, a loop portion 34a, a loop portion 34b, a loop portion 34c, and a loop portion 34d, respectively. Each loop portion is shaped annularly but has a discontinuous section. The coil conductors 32a, 32b, 32c, and 32d also include respective lands, in other words, lands 35a, lands 35b, lands 35c, and lands 35d, respectively. The lands 35a, 35b, 35c, and 35d are formed at the opposite ends of a corresponding one of the loop portions 34a, 34b, 34c, and 34d. The loop portions 34a, 34b, 34c, and 34d may be collectively referred to as loop portions 34.

The via conductors 33a, 33b, 33c, 33d, 33e, and 33f are formed so as to pierce through corresponding insulating layers 31a, 31b, 31c, 31d, 31e, and 31f in the lamination direction. The via conductors 33a, 33b, 33c, 33d, 33e, and 33f may be collectively referred to as via conductors 33.

The land 35e is formed on each via conductor 33e, and the land 35f is formed on each via conductor 33f. Each one of the lands 35a, 35b, 35c, 35d, 35e, and 35f has a width slightly greater than the line width of the corresponding one of the loop portions 34a, 34b, 34c, and 34d. The lands 35a, 35b, 35c, 35d, 35e, and 35f may be collectively referred to as lands 35.

The coil conductors 32, which include the corresponding loop portions 34 and lands 35, and the via conductors 33 are made, for example, of Ag, Au, Cu, Pd, Ni, or Al, or an alloy containing at least one of these.

The insulating layers 31a, 31b, 31c, 31d, 31e, and 31f structured as described above are laminated in the lamination direction. The multilayer body 10 is thereby formed, and the coil conductors 32a, 32b, 32c, and 32d are electrically connected together by respective via conductors 33a, 33b, 33c, and 33d. Thus, a solenoid-type coil having the coil axis extending in the lamination direction is formed inside the multilayer body 10.

In the multilayer body 10, the first extended conductor is made of the via conductors 33e, the lands 35e, and the via conductor 33a that is formed through the insulating layer 31a having the coil conductor 32 positioned closest to the first end surface 11. The first extended conductor is exposed at the first end surface 11 of the multilayer body 10. In other words, the first extended conductor includes the via conductors 33e and 33a and the lands 35e. In the multilayer body 10, the first extended conductor connects between the first outer electrode 21 and the coil conductor 32a that opposes the first outer electrode 21, which will be described later again.

A second extended conductor is made of the via conductors 33f and the lands 35f in the multilayer body 10. The second extended conductor is exposed at the second end surface 12 of the multilayer body 10. In other words, the second extended conductor includes the via conductors 33f and the lands 35f. In the multilayer body 10, the second extended conductor connects between the second outer electrode 22 and the coil conductor 32d that opposes the second outer electrode 22, which will be described later again.

It is preferable that the coil conductors 32 overlap one another as viewed in the lamination direction (in the length direction L). When the coil is viewed in the lamination direction, the coil may have a shape formed of straight lines (for example, a polygonal shape such as a rectangle) as illustrated in FIG. 2, or may have a shape formed of curved lines (for example, a circular shape), or may have a shape formed of straight lines and curved lines.

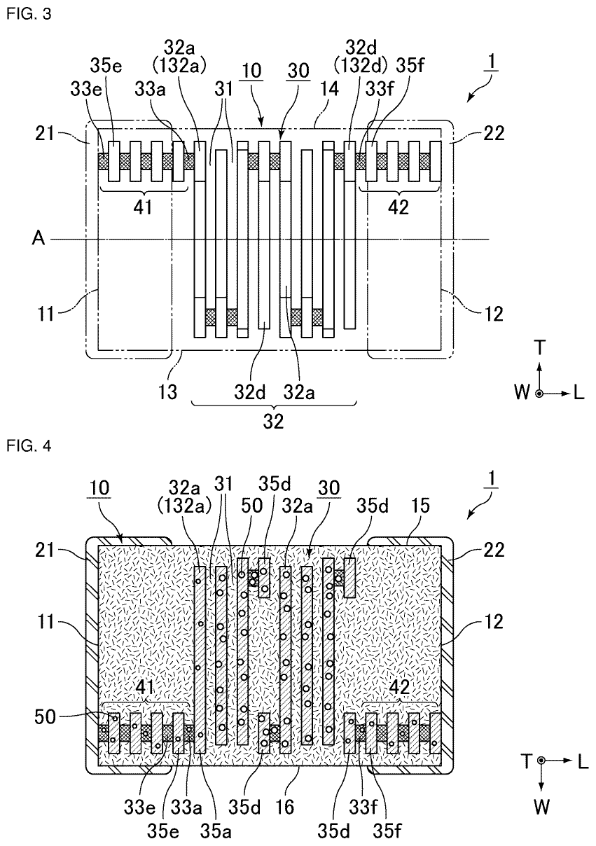

FIG. 3 is a side view schematically illustrating an example internal structure of the multilayer body included in the multilayer coil component of FIG. 1.

As illustrated in FIG. 3, the insulating layers 31 are laminated in the length direction L in the multilayer coil component 1. Accordingly, the length direction L is the lamination direction. In addition, the coil axis A of a coil 30 as well as the lamination direction of the multilayer body 10 extends parallel to the mounting surface, in other words, parallel to the first principal surface 13, the second principal surface 14, the first side surface 15, and the second side surface 16.

Note that the border line between adjacent insulating layers 31 cannot be observed as illustrated in FIG. 3.

In the multilayer body 10, a first extended conductor 41 extends straight in the lamination direction and connects between the first outer electrode 21 disposed on the first end surface 11 and the coil conductor 32a that opposes the first outer electrode 21. Similarly, in the multilayer body 10, a second extended conductor 42 extends straight in the lamination direction and connects between the second outer electrode 22 disposed on the second end surface 12 and the coil conductor 32d that opposes the second outer electrode 22.

Here, the first extended conductor 41 extends in the lamination direction, whereas the coil conductor 32a connected to the first extended conductor 41 extends in a direction orthogonal to the lamination direction. A transition portion (otherwise referred to as an extended-conductor connection portion) between the first extended conductor 41 and the coil conductor 32a connected to the first extended conductor 41 is shaped as a bent portion. Similarly, the second extended conductor 42 extends in the lamination direction, whereas the coil conductor 32d connected to the second extended conductor 42 extends in a direction orthogonal to the lamination direction. A transition portion (otherwise referred to as an extended-conductor connection portion) between the second extended conductor 42 and the coil conductor 32d connected to the second extended conductor 42 is shaped as a bent portion.

When the multilayer body is viewed in the lamination direction (i.e., in the length direction L), the via conductors that form the extended conductor preferably overlap each other. The via conductors of the extended conductor, however, do not need to form a straight line.

FIGS. 2 and 3 illustrate an example in which four coil conductors 32 are laminated and thereby form three turns of the coil 30, in other words, each coil conductor 32 serves as a three-quarter portion of one turn. The number of coil conductors 32 laminated to form one turn of the coil 30 is not specifically limited. For example, two coil conductors 32 may form one turn of the coil 30. In other words, each coil conductor 32 may serve as a one-half portion of one turn of the coil 30.

The number of coil conductors 32 laminated in the multilayer body 10 is not specifically limited but is preferably 30 or more and 120 or less (i.e., from 30 to 120).

FIG. 4 is a cross-sectional view schematically illustrating an example cross section of the multilayer coil component taken along line A1-A1 in FIG. 1. FIG. 4 illustrates a cut surface of the multilayer coil component of FIG. 1. The cut surface is obtained by cutting the multilayer coil component through the first extended conductor and the second extended conductor in parallel with the LW plane.

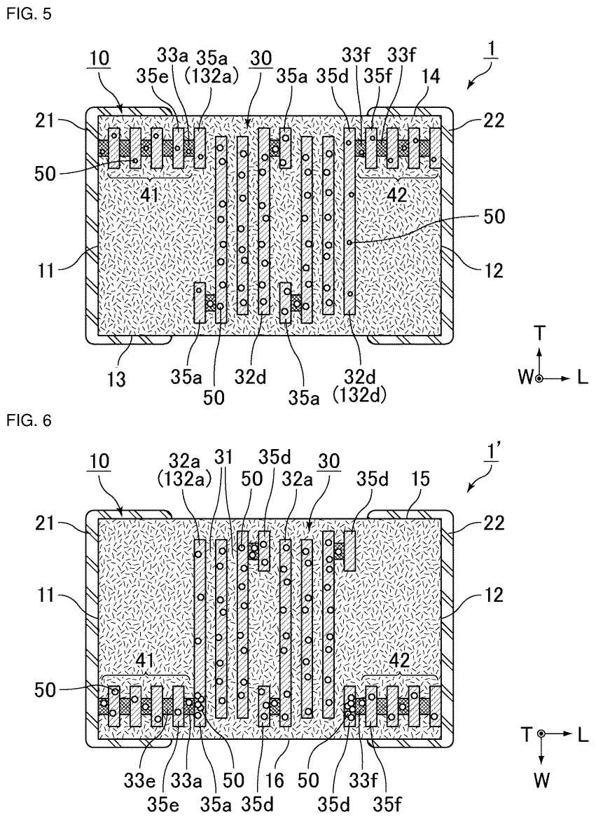

FIG. 5 is a cross-sectional view schematically illustrating an example cross section of the multilayer coil component taken along line A2-A2 in FIG. 1. FIG. 5 illustrates a cut surface of the multilayer coil component of FIG. 1. The cut surface is obtained by cutting the multilayer coil component through the first extended conductor and the second extended conductor in parallel with the LT plane.

Of the coil conductors 32, the coil conductor connected directly to the first extended conductor 41 is referred to as a first coil conductor 132a as illustrated in FIG. 4.

Of the coil conductors 32, the coil conductor connected directly to the second extended conductor 42 is referred to as a second coil conductor 132d as illustrated in FIG. 5.

Accordingly, the multilayer body 10 includes one layer of the first coil conductor 132a and one layer of the second coil conductor 132d. Of the coil conductors 32, the coil conductors other than the first coil conductor 132a and the second coil conductor 132d are referred to as third coil conductors.

As illustrated in FIGS. 4 and 5, pores 50 are formed in the first extended conductor 41 that includes the lands 35e, the via conductors 33e, and the via conductor 33a, and pores 50 are also formed in the second extended conductor 42 that includes the lands 35f and the via conductors 33f. Pores 50 are also formed in the first coil conductor 132a and in the second coil conductor 132d. Similarly, pores 50 are also formed in the coil conductors 32 other than the first coil conductor 132a and the second coil conductor 132d (i.e., the third coil conductors). In addition, pores 50 are also formed in the via conductors 33a, 33b, 33c, and 33d that connect the third coil conductors together.

The sizes of pores may be the same in the first extended conductor, the second extended conductor, the first coil conductor, the second coil conductor, the coil conductors other than the first and second coil conductors (i.e., the third coil conductors). In FIGS. 4 and 5, the sizes of pores 50 formed in the first extended conductor 41, the second extended conductor 42, the first coil conductor 132a, and the second coil conductor 132d are smaller than those formed in the coil conductors 32 other than the first coil conductor 132a and the second coil conductor 132d (i.e., the third coil conductors) and are smaller than those formed in the via conductors 33a, 33b, 33c, and 33d that connect the third coil conductors to each other.

FIGS. 4 and 5 illustrate the pores 50 that are not exposed to the outside of each conductor at the boundary between the conductor and the insulating layer. The pores 50, however, may be exposed to the outside of the conductor and be in contact with the insulating layer 31.

In the multilayer body 10 illustrated in FIGS. 4 and 5, the pore area ratio of each of the first extended conductor 41, the second extended conductor 42, the first coil conductor 132a, and the second coil conductor 132d is 1.00% or more and 11.00% or less (i.e., from 1.00% to 11.00%).

In the case where the pore area ratio of each of the first extended conductor, the second extended conductor, the first coil conductor, and the second coil conductor is 1.00% or more and 11.00% or less (i.e., from 1.00% to 11.00%), the pores do not concentrate easily in the transition portion (i.e., the bent portion or the extended-conductor connection portion) between the coil conductor and the extended conductor, which can reduce the risk of wire breakage.

If the pore area ratio of the first extended conductor, the second extended conductor, the first coil conductor, and the second coil conductor is less than 1.00%, the thermal shrinkage of the coil conductor becomes too great, which produces a large residual stress between the coil conductor and the insulating layer and tends to cause cracks.

Note that the pore area ratio is a ratio of the area of pores (i.e., voids and bubbles) to a unit area of the inner electrode that is formed by baking conductor paste. The pore area ratio can be obtained in the following manner. The multilayer coil component is cut along a plane extending in the lamination direction of the insulating layers through the center of the extended conductors, and the image of the cut surface is obtained using an electron microscope. The obtained image of the cut surface is analyzed using commercially available image analysis software application (for example, “Eizo-kun” (registered trademark), produced by Asahi Kasei Engineering Corporation).

More specifically, for example, in a predetermined region of the inner electrode (for example, a region corresponding to the first extended conductor), the pores and the conductor are converted into a binary representation and thereby distinguished using the image analysis software. The pore area ratio can be obtained by calculating the ratio of the area of pores to the total area of the pores and the conductor. If the first extended conductor 41 and the second extended conductor 42 are not present on the same cross section, two images of respective cross sections of the entire multilayer coil component can be obtained for analysis, the one being the image of the cross section extending through the center of the first extended conductor 41 in the lamination direction of the insulating layers, and the other being the image of the cross section extending through the center of the second extended conductor 42 in the lamination direction of the insulating layers.

FIG. 6 is a cross-sectional view schematically illustrating an example of a multilayer coil component that does not satisfy the features of the present disclosure.

In the multilayer coil component 1′ illustrated in FIG. 6, the pore area ratio of each of the first extended conductor 41, the second extended conductor 42, and the first coil conductor 132a exceeds 11.00%. The pore area ratio of the second coil conductor also exceeds 11.00% although not illustrated. Accordingly, as illustrated in FIG. 6, the pores 50 are concentrated in the connection portion (bent portion) between the first extended conductor 41 and the first coil conductor 132a and also in the connection portion (bent portion) between the second extended conductor 42 and the second coil conductor 132d, thereby increasing the risk of wire breakage at the connection portions.

The pore area ratio of each of the first extended conductor, the second extended conductor, the first coil conductor, and the second coil conductor may be 1.00% or more and 4.00% or less (i.e., from 1.00% to 4.00%).

In the case where the pore area ratio of each of the first extended conductor, the second extended conductor, the first coil conductor, and the second coil conductor is 1.00% or more and 4.00% or less (i.e., from 1.00% to 4.00%), the pores do not concentrate easily in the transition portion (i.e., the bent portion or the extended-conductor connection portion) between the coil conductor and the extended conductor. This reduces the risk of wire breakage. Even if the wire breakage does not occur, this can reduce the likelihood of the electric current passage becoming narrower, in other words, reduce the occurrence of current crowding, due to the pore concentration, thereby leading to reliable electrical continuity.

The thickness of the first coil conductor may be greater than the diameter of the largest pore in the first coil conductor. In the case of the thickness of the first coil conductor being greater than the largest pore diameter, a single pore cannot break the first coil conductor, which can further reduce the risk of wire breakage caused by the pore.

The thickness of the second coil conductor may be greater than the diameter of the largest pore in the second coil conductor. In the case of the thickness of the second coil conductor being greater than the largest pore diameter, a single pore cannot break the second coil conductor, which can further reduce the risk of wire breakage caused by the pore.

Note that the pore diameter is defined as the diameter of an equivalent circle having the area equal to the area of each pore. The largest pore diameter is defined as the largest one among all the calculated diameters of respective pores being present in the target region. For example, the largest pore diameter in the first coil conductor is obtained from the diameter of the equivalent circle of the largest pore being present on a particular cross section in the first coil conductor.

Note that the thickness of the first coil conductor can be obtained in the following manner. The total area of the first coil conductor (including the area of the conductor and the area of the pores) is obtained from the cross-sectional image of the multilayer coil component that is used when the pore diameter is measured. Subsequently, the length of the first coil conductor in the direction orthogonal to the lamination direction of the insulating layers is also obtained from the same cross section. Then, the thickness of the first coil conductor is calculated by dividing the total area of the first coil conductor by the length of the first coil conductor. The thickness of the second coil conductor can be obtained in the same manner.

The largest pore diameter in the first coil conductor is preferably 70% or less, and more preferably 50% or less, of the thickness of the first coil conductor. The largest pore diameter in the first coil conductor is preferably 10% or more, and more preferably 30% or more, of the thickness of the first coil conductor. The largest pore diameter in the second coil conductor is preferably 70% or less, and more preferably 50% or less, of the thickness of the second coil conductor. The largest pore diameter in the second coil conductor is preferably 10% or more, and more preferably 30% or more, of the thickness of the second coil conductor.

Regarding the third coil conductors (i.e., the coil conductors other than the first coil conductor and the second coil conductor), the pore area ratio of at least one of the third coil conductors is preferably greater than that of the first coil conductor and of the second coil conductor.

The pore area ratio of at least one of the third coil conductors, which are the coil conductors other than the first coil conductor and the second coil conductor, is preferably more than 11.00% and 20.00% or less (i.e., from more than 11.00% to 20.00%). The coil conductor having a pore area ratio of more than 11.00% and 20.00% or less (i.e., from more than 11.00% to 20.00%) is a coil conductor having a greater shrinkage factor when the coil conductor is sintered.

In the case of at least one of the third coil conductors being such a coil conductor, the shrinkage factor of the coil conductor can be brought closer to the shrinkage factor of the insulating layer when the multilayer body is sintered. This can reduce the likelihood of the electric characteristics of the coil being degraded due to the difference in shrinkage factor between the insulating layer and the coil conductor.

Note that the third coil conductors (i.e., the coil conductors other than the first coil conductor and the second coil conductor) are positioned further away from the bent portion than the first or the second coil conductor because the third coil conductors are connected to the first extended conductor or to the second extended conductor via the loop portion of the first coil conductor or of the second coil conductor. Accordingly, it is highly unlikely that pores formed in the third coil conductors migrate to the bent portion during sintering. Accordingly, even if the pore area ratios of the third coil conductors exceed 11.00%, this does not increase the risk of wire breakage at the bent portion (i.e., the extended-conductor connection portion).

On the other hand, if the third coil conductors, which are the coil conductors other than the first coil conductor and the second coil conductor, do not include any coil conductor of which the pore area ratio is 20.00% or less, in other words, if the pore area ratios of all of the third coil conductors exceed 20.00%, the Rdc (i.e., internal resistance) of the coil or the inner electrode becomes high. That is, all of the third coil conductors, in other words, all of the coil conductors except for the first coil conductor and the second coil conductor preferably have a pore area ratio of 20.00% or less.

Two or more of the third coil conductors may have a pore area ratio of more than 11.00% and 20.00% or less (i.e., from more than 11.00% to 20.00%), and some of the third coil conductors may have a pore area ratio of 11.00% or less. However, the number of the third coil conductors having a pore area ratio of 11.00% or less is preferably smaller than the number of the third coil conductors having a pore area ratio of more than 11.00% and 20.00% or less (i.e., from more than 11.00% to 20.00%).

A half or more of all the third coil conductors preferably has a pore area ratio of more than 11.00% and 20.00% or less (i.e., from more than 11.00% to 20.00%).

In the case where the third coil conductors other than the first coil conductor and the second coil conductor include two types of coil conductors, in other words, the coil conductors having a pore area ratio of 11.00% or less and the coil conductors having a pore area ratio of more than 11.00% and 20.00% or less (i.e., from more than 11.00% to 20.00%), the arrangement of two types of the coil conductors is not specifically limited. It is preferable, however, that the coil conductors having a pore area ratio of 11.00% or less be positioned closer to the first coil conductor or to the second coil conductor than the coil conductors having a pore area ratio of more than 11.00% and 20.00% or less (i.e., from more than 11.00% to 20.00%). It is more preferable that the coil conductors having a pore area ratio of 11.00% or less be positioned next to the first coil conductor or next to the second coil conductor in the lamination direction.

It is preferable that all of the third coil conductors, in other words, all of the coil conductors other than the first coil conductor and the second coil conductor, have a pore area ratio of more than 11.00% and 20.00% or less (i.e., from more than 11.00% to 20.00%). In the case of all of the third coil conductors having a pore area ratio of more than 11.00% and 20.00% or less (i.e., from more than 11.00% to 20.00%), all the coil conductors except for the first coil conductor and the second coil conductor exhibit a greater shrinkage during sintering, which can bring the shrinkage factors of the coil conductors closer to that of the insulating layer at its maximum when the multilayer body is sintered. This can further reduce the likelihood of the electric characteristics of the coil being degraded due to the difference in shrinkage factor between the insulating layer and the coil conductor.

It is preferable that the largest pore diameter of each of the first extended conductor, the second extended conductor, the first coil conductor, and the second coil conductor be smaller than the largest pore diameter of each of the third coil conductors (i.e., the coil conductors other than the first coil conductor and the second coil conductor). Satisfying this condition can further reduce the risk of wire breakage occurring in the first extended conductor, the second extended conductor, the first coil conductor, and the second coil conductor due to the presence of pores.

Note that the largest pore diameter of the coil conductors other than the first coil conductor and the second coil conductor is defined as the diameter of the largest one of the pores present in the third coil conductors (i.e., the coil conductors other than the first coil conductor and the second coil conductor).

In the case where at least one of the third coil conductors (i.e., the coil conductors other than the first coil conductor and the second coil conductor) has a pore area ratio of more than 11.00% and 20.00% or less (i.e., from more than 11.00% and 20.00%), it is preferable that the largest pore of the coil conductors other than the first coil conductor and the second coil conductor be present in the coil conductor having a pore area ratio of more than 11.00% and 20.00% or less (i.e., from more than 11.00% to 20.00%). In this case, it is also preferable that the largest pore diameter of each of the coil conductors having a pore area ratio of more than 11.00% and 20.00% or less (i.e., from more than 11.00% to 20.00%) be greater than the largest pore diameter of each of the first extended conductor, the second extended conductor, the first coil conductor, and the second coil conductor.

The via conductors for forming the first extended conductor are referred to as first via conductors, and the via conductors for forming the second extended conductor are referred to as second via conductors. The via conductors of the inner electrode other than the first via conductors and the second via conductors are referred to as third via conductors. The third via conductors may have pores.

The pore area ratio for the third via conductor is not specifically limited but is preferably the same as the pore area ratio for the third coil conductor. In other words, it is preferable that the pore area ratio of the third via conductor be more than 11.00% and 20.00% or less (i.e., from more than 11.00% to 20.00%).

The distribution of the pore diameters in the third via conductor is not specifically limited but is preferably similar to the distribution of the pore diameters in the third coil conductor. For example, the largest pore diameter of the third via conductor may be equal to the largest pore diameter of the third coil conductor.

The largest pore diameter of the third coil conductors and the third via conductors having a pore area ratio of more than 11.00% and 20.00% or less (i.e., from more than 11.00% to 20.00%) is preferably greater than the largest pore diameter of each of the first extended conductor, the second extended conductor, the first coil conductor, and the second coil conductor.

It is preferable that the insulating layer contain ferrite and have a pore area ratio of 0.10% or more and 5.00% or less (i.e., from 0.10% to 5.00%).

In the case where the insulating layer contains ferrite and has a pore area ratio of 0.10% or more and 5.00% or less (i.e., from 0.10% to 5.00%), the electric resistance of the insulating layer is sufficiently high and a short circuit between adjacent coil conductors through the insulating layer is not likely to occur even if a large current flows. If the pore area ratio of the insulating layer exceeds 5.00%, adjacent coil conductors with an insulating layer being interposed therebetween may be vulnerable to short-circuiting.

The insulating layer that contains ferrite and has a pore area ratio of 0.10% or more and 5.00% or less (i.e., from 0.10% to 5.00%) shrinks largely during sintering. In such a case, the shrinkage of the insulating layer during sintering may cause a stress in the coil conductor and may deteriorate electric characteristics (or magnetic permeability).

However, in the case where at least one of the coil conductors except for the first coil conductor and the second coil conductor has a pore area ratio of more than 11.00% and 20.00% or less (i.e., from more than 11.00% to 20.00%), the shrinkage factor of the coil conductor (i.e., the shrinkage factor of the conductor paste to become the coil conductor) can be brought closer to the shrinkage factor of the insulating layer. As a result, even if the insulating layer contains ferrite and has a pore area ratio of 0.10% or more and 5.00% or less (i.e., from 0.10% to 5.00%), the stress generation in the coil conductor can be reduced, and the deterioration of the electric characteristics (magnetic permeability) is thereby reduced.

In the present specification, the expression “a coil conductor is connected directly to an extended conductor” means that the coil conductor is connected to the extended conductor without the loop portion of another coil conductor being interposed therebetween. Accordingly, in the case of the first extended conductor being connected directly to multiple coil conductors without the loop portions of other coil conductors being interposed, a plurality of the first coil conductors is present in the coil. Similarly, in the case of the second extended conductor being connected directly to multiple coil conductors without the loop portions of other coil conductors being interposed, a plurality of the second coil conductors is present in the coil.

A second embodiment of the present disclosure will be described through an example of a multilayer coil component that includes two layers of the first coil conductors and two layers of the second coil conductors.

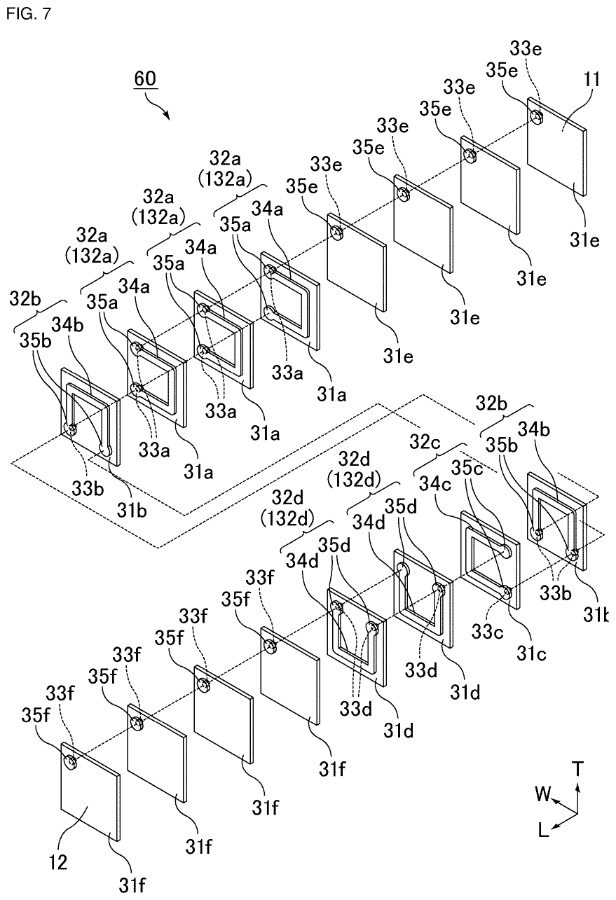

FIG. 7 is an exploded perspective view schematically illustrating a multilayer body of an example multilayer coil component according to the second embodiment of the present disclosure.

As illustrated in FIG. 7, a multilayer body 60 is formed by laminating multiple insulating layers 31a, 31b, 31c, 31d, 31e, and 31f in the lamination direction (i.e., in the length direction L in this case) from the first end surface 11 toward the second end surface 12 of the multilayer body 60.

When the insulating layers having the coil conductor are counted from the one positioned closest to the first end surface 11 (i.e., the first insulating layer 31a), each one of the loop portions 34a of the second and third insulating layers 31a has the lands 35a disposed at respective opposite ends thereof and has the via conductors 33a formed beneath respective lands 35a, which is different from the first insulating layer 31a.

As is similar to the insulating layers 31a above, when the insulating layers having the coil conductor are counted from the first insulating layer 31a positioned closest to the first end surface 11, the loop portion 34b of the fifth insulating layer 31b has the lands 35b disposed at respective opposite ends thereof and has the via conductors 33b formed beneath respective lands 35b, which is different from the fourth insulating layer 31b.

As is similar to the insulating layers 31a and 31b above, when the insulating layers having the coil conductor are counted from the first insulating layer 31a positioned closest to the first end surface 11, the loop portion 34d of the eighth insulating layer 31d has the lands 35d disposed at respective opposite ends thereof and has the via conductors 33d formed beneath respective lands 35d, which is different from the seventh insulating layer 31d. Accordingly, the coil conductors of which the shapes of the loop portions are the same (such as the coil conductors 32a, the coil conductors 32b, and the coil conductors 32d) are connected in parallel to each other.

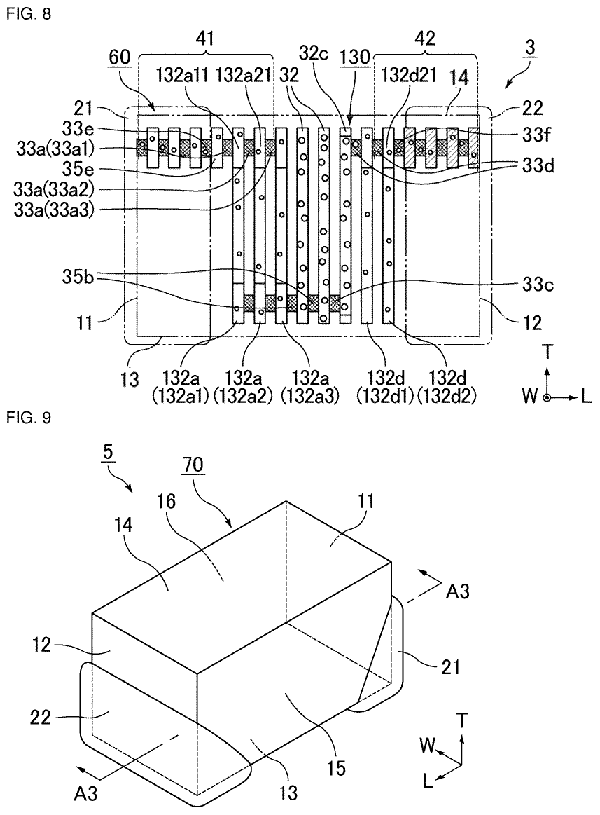

FIG. 8 is a side view schematically illustrating a state of pores of the inner electrode included in the multilayer coil component having the multilayer body of FIG. 7.

As illustrated in FIG. 8, a multilayer coil component 3 includes a multilayer body 60, a first outer electrode 21, and a second outer electrode 22. The first outer electrode 21 covers the first end surface 11 of the multilayer body 60, and the second outer electrode 22 covers the second end surface 12. The multilayer body 60 includes the first extended conductor 41, the second extended conductor 42, and a coil 130, those of which serve as an inner electrode and are arranged inside the multilayer body 60.

When the coil conductors 32 are counted from the one closest to the first end surface 11, the first-layer coil conductor 32a, the second-layer coil conductor 32a, the third-layer coil conductor 32a are connected in the lamination direction in the multilayer body 60 using a via conductor 33a2 and a via conductor 33a3. Accordingly, when the coil conductors 32 are counted from the one closest to the first end surface 11, the first-layer coil conductor 32a (132a1), the second-layer coil conductor 32a (132a2), and the third-layer coil conductor 32a (132a3) are connected directly to the first extended conductor 41 and accordingly serve as the first coil conductors. The first coil conductors 132a1, 132a2, and 132a3 may be collectively referred to as first coil conductors 132a.

Similarly, when the coil conductors 32 are counted from the one closest to the first end surface 11, the seventh-and eighth-layer coil conductors 32d are connected to each other in the lamination direction using the via conductor 33f. Accordingly, when the coil conductors 32 are counted from the one closest to the first end surface 11, the seventh-layer coil conductor 132d1 and the eighth-layer coil conductor 132d2 are connected directly to the second extended conductor 42 and accordingly serve as the second coil conductors. The second coil conductors 132d1 and 132d2 may be collectively referred to as second coil conductors 132d. In FIG. 8, the via conductor 33f cannot be viewed between the coil conductors 132d1 and 132d2 because one of the via conductors 33d overlaps the via conductor 33f.

Note that the coil conductors other than the first coil conductors 132a and the second coil conductors 132d are connected to the first extended conductor 41 or to the second extended conductor 42 via the loop portions 34a of the first coil conductors 132a or via the loop portions 34d of the second coil conductors 132d. Accordingly, these coil conductors, other than the first coil conductors 132a and the second coil conductors 132d, are not the coil conductors directly connected to the first extended conductor 41 or to the second extended conductor 42.

The first coil conductors 132a1, 132a2, and 132a3 having the similar loop portions 34a are connected in parallel using the via conductors 33a. Similarly, two coil conductors 32b having the similar loop portions 34b are connected in parallel using the via conductors 33b, and the second coil conductors 132d1 and 132d2 having the similar loop portions 34d are connected in parallel using the via conductors 33d.

The coil configured as above is called a parallel-wound coil (inductor).

In the case where multiple first coil conductors are provided and a portion of a first coil conductor is sandwiched in between via conductors in the lamination direction, such a portion is to be included in the first extended conductor. For example, as illustrated in FIG. 8, three first coil conductors 132a1, 132a2, and 132a3 are connected directly to the first extended conductor 41, and the via conductor 33a2 connects between the first coil conductor 132a1 and the first coil conductor 132a2, and the via conductor 33a3 connects between the first coil conductor 132a2 and the first coil conductor 132a3. In this case, a portion 132a11 of the first coil conductor 132a1 sandwiched in between the via conductor 33a1 and the via conductor 33a2 is regarded as the first extended conductor 41. Similarly, a portion 132a21 of the first coil conductor 132a2 that is sandwiched in between the via conductor 33a2 and the via conductor 33a3 is also regarded as the first extended conductor 41.

Similarly, two second coil conductors 132d1 and 132d2 are connected directly to the second extended conductor 42, and the via conductor 33d connects between the second coil conductor 132d1 and the second coil conductor 132d2. In this case, a portion 132d21 of the second coil conductor 132d2 that is sandwiched in between the via conductor 33d and the via conductor 33f of the second extended conductor 42 is regarded as the second extended conductor 42.

In the multilayer body 60 illustrated in FIG. 8, each one of the first extended conductor 41, the second extended conductor 42, the first coil conductors 132a1, 132a2, and 132a3, and the second coil conductors 132d1 and 132d2 has a pore area ratio of 1.00% or more and 11.00% or less (i.e., from 1.00% to 11.00%).

During sintering, bubbles are generated in conductor paste and are attracted to the outside. This occurs most intensively at an exposed portion of the inner electrode in the multilayer body, in other words, an exposed portion of the extended conductor. The deeper in the multilayer body, the more mildly this occurs. Accordingly, in the case of multiple first coil conductors being provided, the pore area ratio of all of the first coil conductors is set to be 1.00% or more and 11.00% or less (i.e., from 1.00% to 11.00%), which can reduce the risk of wire breakage. Similarly, in the case of multiple second coil conductors being provided, the pore area ratio of all of the second coil conductors is set to be 1.00% or more and 11.00% or less (i.e., from 1.00% to 11.00%), which can reduce the risk of wire breakage.

The present disclosure can be applied not only to a horizontal-winding lamination coil component, in other words, to a coil component of which the lamination direction of the insulating layers and the extending direction of the extended conductors are parallel to the mounting surface. The present disclosure can be also applied to a vertical-winding lamination coil component, in other words, a coil component of which the lamination direction of the insulating layers and the extending direction of the extended conductors orthogonally intersect the mounting surface.

An example of the vertical-winding lamination coil component will be described as a multilayer coil component according to the third embodiment of the present disclosure.

FIG. 9 is a perspective view schematically illustrating an example of a multilayer coil component according to a third embodiment of the present disclosure.

As illustrated in FIG. 9, a multilayer coil component 5 includes a multilayer body 70, the first outer electrode 21, and the second outer electrode 22. The multilayer body 70 includes the first end surface 11 and the second end surface 12 that are opposite to each other in the length direction L. The multilayer body 70 also includes the first principal surface 13 and the second principal surface 14 that are opposite to each other in the height direction T that orthogonally intersects the length direction L. The multilayer body 70 also includes the first side surface 15 and the second side surface 16 that are opposite to each other in the width direction W that orthogonally intersects the length direction L and the height direction T.

The first outer electrode 21 covers part of the first end surface 11. The first outer electrode 21 extends from the part of the first end surface 11 and covers part of the first principal surface 13 that serves as the mounting surface. The first outer electrode 21 extends from the part of the first end surface 11 and from the part of the first principal surface 13 and covers part of the first side surface 15 and part of the second side surface 16. Accordingly, the first outer electrode 21 is shaped like an inclined electrode.

The second outer electrode 22 covers part of the second end surface 12. The second outer electrode 22 extends from the part of the second end surface 12 and covers part of the first principal surface 13 that serves as the mounting surface. The second outer electrode 22 extends from the part of the second end surface 12 and from the part of the first principal surface 13 and covers part of the first side surface 15 and part of the second side surface 16. Accordingly, the second outer electrode 22 is shaped like an inclined electrode.

The shapes of the first outer electrode and the second outer electrode are not limited to the inclined electrodes as described above but may have the same shapes as those of multilayer coil component 1 illustrated in FIGS. 1 to 5 or of the multilayer coil component 3 illustrated in FIGS. 7 and 8.

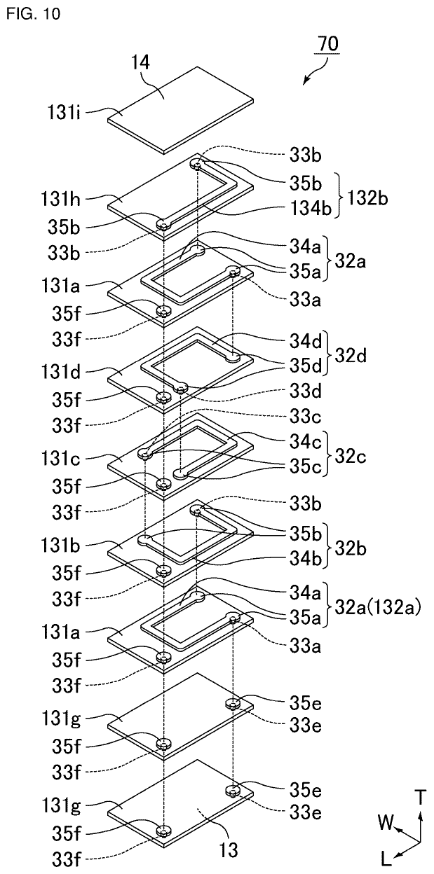

FIG. 10 is an exploded perspective view schematically illustrating an example multilayer body included in the multilayer coil component of FIG. 9.

As illustrated in FIG. 10, the multilayer body 70 is formed by laminating multiple insulating layers 131a, 131b, 131c, 131d, 131g, 131h, and 131i in the lamination direction (i.e., in the height direction T in this case) from the first principal surface 13 toward the second principal surface 14 of the multilayer body 70. The insulating layers 131a, 131b, 131c, 131d, 131g, 131h, and 131i may be collectively referred to as insulating layers 131.

The insulating layers 131a, 131b, 131c, and 131d include the coil conductors 32a, 32b, 32c, and 32d and the via conductors 33a, 33b, 33c, and 33d, respectively. Each of the insulating layers 131a, 131b, 131c, and 131d includes the land 35f and the via conductor 33f.

The coil conductors 32a, 32b, 32c, and 32d include respective loop portions, in other words, the loop portion 34a, the loop portion 34b, the loop portion 34c, and the loop portion 34d, respectively. Each loop portion is shaped annularly but has a discontinuous section. The coil conductors 32a, 32b, 32c, and 32d also include respective lands, in other words, the lands 35a, the lands 35b, the lands 35c, and the lands 35d, respectively. The lands 35a, 35b, 35c, and 35d are formed at the opposite ends of a corresponding one of the loop portions 34a, 34b, 34c, and 34d. The land 35f and the via conductor 33f are also formed at a position spaced from the corresponding one of the coil conductors 32a, 32b, 32c, and 32d.

The insulating layer 131h has a coil conductor 132b and the via conductors 33b formed therein. The coil conductor 132b includes a loop portions 134b that partially overlaps the loop portion 34b of the coil conductor 32b. The coil conductor 132b also includes lands 35b formed at opposite ends of the loop portion 134b.

The insulating layer 131g includes the lands 35e and 35f and the via conductors 33e and 33f formed therein. A single insulating layer 131g or multiple insulating layers 131g may be provided.

The insulating layer 131i has no coil conductor, no land, and no via conductor. A single insulating layer 131i or multiple insulating layers 131i may be provided.

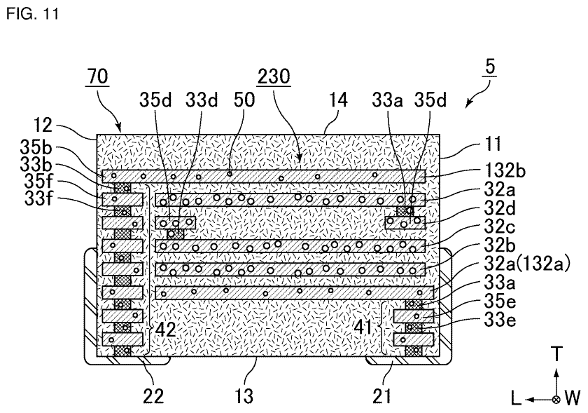

FIG. 11 is a cross-sectional view schematically illustrating an example cross section of the multilayer coil component taken along line A3-A3 in FIG. 9.

As illustrated in FIG. 11, the multilayer body 70 includes an inner electrode formed of the first extended conductor 41, the second extended conductor 42, and a coil 230. The coil 230 is formed of the coil conductors 132a, 32b, 32c, 32d, 32a, and 132b that are electrically connected in the lamination direction using the via conductors 33a, 33b, 33c, and 33d.

In the multilayer body 70, the first extended conductor 41 is made of the via conductors 33e and the lands 35e and also of the via conductor 33a that is formed in the insulating layer 131a positioned next to the insulating layers 131g. The first extended conductor 70 is exposed at the first principal surface 13 at a position near the first end surface 11 of the multilayer body 70.

The insulating layers 131h has two lands 35b, and one of the two lands 35b does not overlap the loop portion of the coil. This land 35b and a via conductor 33b formed therebeneath serve as the second extended conductor 42. The second extended conductor 42 also includes the lands 35f and the via conductors 33f. The second extended conductor 42 extends through the multilayer body 70 and is exposed at the first principal surface 13 at a position near the second end surface 12 of the multilayer body 70.

The first extended conductor 41 and the second extended conductor 42 extend in the direction that is parallel to the lamination direction of the insulating layers and is orthogonal to the first principal surface 13 that serves as the mounting surface. The first extended conductor 41 and the second extended conductor 42 are exposed at the same surface of the multilayer body 70 (i.e., the first principal surface 13).

Of the coil conductors, the coil conductor 32a connected directly to the first extended conductor 41 is a first coil conductor 132a.

Of the coil conductors, the coil conductor 132b connected directly to the second extended conductor 42 is the second coil conductor.

Accordingly, the multilayer body 70 includes one layer of the first coil conductor 132a and one layer of the second coil conductor 132b. The coil conductors other than the first coil conductor 132a and the second coil conductor 132b are referred to as third coil conductors.

As illustrated in FIG. 11, pores 50 are formed in the first extended conductor 41 that includes the via conductors 33a and 33e and the lands 35e. Pores 50 are also formed in the second extended conductor 42 that includes the via conductors 33b and 33f and the lands 35b and 35f. Similarly, pores 50 are formed in the third coil conductors (i.e., the coil conductors other than the first coil conductor 132a and the second coil conductor 132b), in other words, the coil conductors 32a, 32b, 32c, and 32d. In addition, pores 50 are also formed in the via conductors 33a, 33b, 33c, and 33d that connect the third coil conductors together.

In the multilayer body 70 illustrated in FIG. 11, the pore area ratio of each of the first extended conductor 41, the second extended conductor 42, the first coil conductor 132a, and the second coil conductor 132b is 1.00% or more and 11.00% or less (i.e., from 1.00% to 11.00%).

Whether the lamination direction of the coil conductors is parallel to the mounting surface or perpendicular to the mounting surface, pores are generated in the extended conductors and in the vicinity thereof and are attracted toward the outside when the conductor paste is sintered. Accordingly, even if the multilayer coil component 1 is a vertical-winding lamination coil component, the pore area ratio of each of the first extended conductor 41, the second extended conductor 42, the first coil conductor 132a, and the second coil conductor 132b is 1.00% or more and 11.00% or less (i.e., from 1.00% to 11.00%). This can reduce the risk of wire breakage at the extended-conductor connection portion as is the case for the horizontal-winding lamination coil component illustrated in FIGS. 1 to 5.

### Method of Manufacturing Multilayer Coil Component

In a method of manufacturing a multilayer coil component according to a first embodiment of the present disclosure, the multilayer coil component includes i) a multilayer body formed by laminating multiple insulating layers and having an inner electrode, and ii) a first outer electrode and a second outer electrode each of which is electrically connected to the inner electrode. The inner electrode includes i) a coil formed by laminating multiple coil conductors together with the insulating layers, the coil conductors being electrically connected together, ii) a first extended conductor connecting between the coil and the first outer electrode, and iii) a second extended conductor connecting between the coil and the second outer electrode. The first extended conductor and the second extended conductor extend in a lamination direction in which the insulating layers are laminated. The method of manufacturing the multilayer coil component includes i) a step of preparing ceramic green sheets containing a ceramic material, ii) a printing step of forming conductor paste layers by applying a conductor paste onto the ceramic green sheets, the conductor paste layers corresponding to the coil conductors, the first extended conductor, and/or the second extended conductor, iii) a step of preparing an unsintered multilayer body containing an unsintered coil by laminating the ceramic green sheets with the conductor paste layers formed thereon, and iv) a step of sintering the unsintered multilayer body to obtain a multilayer body. Among the coil conductors, a coil conductor connected directly to the first extended conductor is a first coil conductor, and a coil conductor connected directly to the second extended conductor is a second coil conductor. A PVC of the conductor paste for forming the first extended conductor, the second extended conductor, the first coil conductor, and the second coil conductor is 45.00% or more and 55.00% or less (i.e., from 45.00% to 55.00%).

An example method of manufacturing the multilayer coil component of the present disclosure will be described.

### Preparation of Magnetic Material

Fe₂O₃, ZnO, CuO, and NiO are first weighed in accordance with a predetermined ratio.

Next, the above weighed materials, pure water, and others are mixed together with PSZ (partially stabilized zirconia) media in a ball mill, and the mixture is pulverized. The duration of mixing and pulverizing is, for example, four hours or more and 8 hours or less (i.e., from four hours to 8 hours).

The pulverized material obtained is dried and calcined. The calcination temperature is, for example, 700° C. or more and 800° C. or less (i.e., from 700° C. to 800° C.). The calcination duration is, for example, 2 hours or more and 5 hours or less (i.e., from 2 hours to 5 hours).

Thus, a pulverized magnetic material, more specifically, a pulverized magnetic ferrite material is prepared.

The ferrite material is preferably a Ni—Cu—Zn-based ferrite material.

The Ni—Cu—Zn-based ferrite material preferably contains, when the total amount is 100 mol %, 40 mol % or more and 49.5 mol % or less (i.e., from 40 mol % to 49.5 mol %) of Fe in the form of Fe203, 2 mol % or more and 35 mol % or less (i.e., from 2 mol % to 35 mol %) of Zn in the form of ZnO, 6 mol % or more and 13 mol % or less (i.e., from 6 mol % to 13 mol %) of Cu in the form of CuO, and 10 mol % or more and 45 mol % or less (i.e., from 10 mol % to 45 mol %) of Ni in the form of NiO.

The Ni—Cu—Zn-based ferrite material can contain additives, such as Co, Bi, Sn, and Mn.

The Ni—Cu—Zn-based ferrite material can also contain inevitable impurities.

### Preparation of Green Sheet

Subsequently, the magnetic material together with the PSZ media is mixed in a ball mill with, for example, an organic binder such as a polyvinylbutyral-based resin, an organic solvent such as ethanol or toluene, and a plasticizer, and the mixture is pulverized to prepare a slurry.

Next, the slurry is spread using the doctor blade method or the like so as to form a sheet with a predetermined thickness. Green sheets having a predetermined shape are punched out of the sheet. The thickness of a green sheet is, for example, 20 μm or more and 30 μm or less (i.e., from 20 μm to 30 μm). The shape of the green sheet is, for example, substantially rectangular.

The material of the green sheet is not limited to the above magnetic material but can be a non-magnetic material, such as borosilicate glass, or a mixture of a magnetic material and a non-magnetic material.

### Formation of Conductor Traces

Via holes are first formed by emitting laser beam to a green sheet at predetermined positions.

Next, a conductor paste containing a conductive material, a resin component, and a solvent is applied onto the surface of the green sheet using the screen printing method or the like while the via holes are filled with the conductor paste. Accordingly, the conductor traces for the via conductors are formed at respective via holes on the green sheet, and the conductor traces for the coil conductors and/or for the lands are also formed so as to be connected to the conductor traces for the via conductors. Coil sheets are thereby produced. The coil sheets are the green sheets on which the conductor traces for the coil conductors and/or the lands and the conductor traces for the via conductors are formed. The conductor traces for the coil conductors formed on respective coil sheets correspond to the coil conductors 32 illustrated in FIG. 2. The conductor traces for the via conductors formed on respective coil sheets correspond to the via conductors 33 illustrated in FIG. 2 (excluding the via conductors 33e and 33f). Via sheets are prepared separately from the preparation of the coil sheets. The conductor traces for the via conductors formed on respective via sheets correspond to the via conductors 33e and 33f illustrated in FIG. 2.

According to the method of manufacturing the multilayer coil component of the first embodiment of the present disclosure, the PVC (see below) of the conductor paste in this step is set to be 45.00% or more and 55.00% or less (i.e., from 45.00% to 55.00%) for forming the conductor traces for the first extended conductor (i.e., the conductor traces of the lands and the via conductors for the first extended conductor), the second extended conductor (i.e., the conductor traces of the lands and the via conductors for the second extended conductor), the first coil conductor (i.e., the conductor trace of the coil conductor for the first coil conductor), and the second coil conductor (i.e., the conductor trace of the coil conductor for the second coil conductor).

Accordingly, the pore area ratio of each of the first extended conductor, the second extended conductor, the first coil conductor, and the second coil conductor can stay in the range of 1.00% or more and 11.00% or less (i.e., from 1.00% or more and 11.00%) by setting the PVC of the conductor paste to be in the range of 45.00% or more and 55.00% or less (i.e., from 45.00% to 55.00%) for the first extended conductor, the second extended conductor, the first coil conductor, and the second coil conductor. Thus, the multilayer coil component of the present disclosure can be obtained.

Note that the PVC is short for the pigment volume concentration, which herein refers to the concentration in volume of the conductive material (typically metal powder) contained in the conductor paste with respect to the total volume of the conductive material and the resin component in the conductor paste. The PVC indicates the volume ratio of the non-resin component in the conductor paste. The conductor traces formed using a conductor paste having a relatively high PVC have a smaller pore area ratio compared with the conductor traces formed using a conductor paste having a relatively low PVC.

For example, the conductive material is a metal powder of Ag, Au, Cu, Pd, Ni, or Al, or an alloy containing at least one of these, with an Ag powder being preferred.

An example of the resin component is ethyl cellulose.

In the present specification, the conductor paste for forming the first extended conductor, the second extended conductor, the first coil conductor, and the second coil conductor is also referred to as a “low-porosity conductor paste”.

In the method of manufacturing the multilayer coil component according to the first embodiment of the present disclosure, the low-porosity conductor paste is a conductor paste with a PVC of 45.00% or more and 55.00% or less (i.e., from 45.00% to 55.00%).

The low-porosity conductor paste may be used for the coil conductors other than the first and second coil conductors. In this case, however, it is preferable that at least one layer be formed using a conductor paste with a PVC of 30.00% or more and 40.00% or less (i.e., from 30.00% to 40.00%).

Put another way, at least one of the coil conductors other than the first and second coil conductors is formed using the conductor paste with a PVC of 30.00% or more and 40.00% or less (i.e., from 30.00% to 40.00%). As a result, the pore area ratio of at least one of the coil conductors other than the first and second coil conductors can stay in the range of more than 11.00% and 20.00% or less (i.e., from more than 11.00% to 20.00%).

In the case of the pore area ratio of at least one of the coil conductors other than the first and second coil conductors being in the range of more than 11.00% and 20.00% or less (i.e., from more than 11.00% to 20.00%), the shrinkage factor of the coil conductors can be made closer to the shrinkage factor of the insulating layers when the multilayer body is sintered. This can reduce the likelihood of the electric characteristics of the coil being degraded due to the difference in shrinkage factor between the insulating layers and the coil conductors.

It is more preferable that the PVC of the conductor paste for forming a half or more of all the layers of coil conductors except for the first and second coil conductors be 30.00% or more and 40.00% or less (i.e., from 30.00% to 40.00%). As a result, the pore area ratio of a half or more of all the coil conductors except for the first and second coil conductors can be made to stay in the range of more than 11.00% and 20.00% or less (i.e., from more than 11.00% to 20.00%), which enables the shrinkage factor of the coil conductors to be made even closer to the shrinkage factor of the insulating layers when the multilayer body is sintered. This can reduce the likelihood of the electric characteristics of the coil being degraded due to the difference in shrinkage factor between the insulating layers and the coil conductors.

It is still more preferable that the PVC of the conductor paste for all the coil conductors except for the first and second coil conductors be 30.00% or more and 40.00% or less (i.e., from 30.00% to 40.00%).

In the case of the conductor paste for all the coil conductors except for the first and second coil conductors having a PVC of 30.00% or more and 40.00% or less (i.e., from 30.00% to 40.00%), the pore area ratio of all the coil conductors except for the first and second coil conductors can be made to stay in the rage of more than 11.00% or 20.00% or less (i.e., from more than 11.00% to 20.00%).

When the pore area ratio of all of the coil conductors except for the first and second coil conductors is in the rage of more than 11.00% or 20.00% or less (i.e., from more than 11.00% to 20.00%), all of the coil conductors except for the first and second coil conductors have a greater shrinkage factor in sintering, which can make the shrinkage factor of the coil conductors to be as close as possible to the shrinkage factor of the insulating layers when the multilayer body is sintered. This can further reduce the likelihood of the electric characteristics of the coil being degraded due to the difference in shrinkage factor between the insulating layers and the coil conductors.

In the present specification, the conductor paste for forming the coil conductor layers having a pore area ratio of more than 11.00% and 20.00% or less (i.e., from more than 11.00% to 20.00%) is also referred to as a “high-porosity conductor paste”.

In the method of manufacturing the multilayer coil component according to the first embodiment of the present disclosure, the high-porosity conductor paste is a conductor paste with a PVC of 30.00% or more and 40.00% or less (i.e., from 30.00% to 40.00%).

Put another way, in the method of manufacturing the multilayer coil component according to the first embodiment of the present disclosure, it is preferable to use the low-porosity conductor paste for forming the first extended conductor, the second extended conductor, the first coil conductor, and the second coil conductor and also to use the high-porosity conductor paste for forming at least one of the coil conductors (i.e., the third coil conductors) other than the first and second coil conductors. It is more preferable to use the high-porosity conductor paste for forming a half of all the layers of the third coil conductors. It is still more preferable to use the high-porosity conductor paste for forming all of the third coil conductors.

The above-described high-porosity conductor paste may be used for forming conductor traces for the via conductors other than those of the first and second extended conductors. This enables the pore area ratio of the via conductors (i.e., the third via conductors) other than the first and second via conductors to stay in the range of more than 11.00% and 20.00% or less (i.e., from more than 11.00% to 20.00%).

The largest pore diameter in the conductors formed using the low-porosity conductor paste tends to be smaller than the largest pore diameter in the conductors formed using the high-porosity conductor paste. Accordingly, the conductor paste having a PVC of 45.00% or more and 55.00% or less (i.e., from 45.00% to 55.00%) (i.e., the low-porosity conductor paste) is used to form the first extended conductor, the second extended conductor, the first coil conductor, and the second coil conductor, while the conductor paste having a PVC of 30.00% or more and 40.00% or less (i.e., from 30.00% to 40.00%) (i.e., the high-porosity conductor paste) is used to form at least one of the coil conductors other than the first and second coil conductors. As a result, the largest pore diameter of each of the first extended conductor, the second extended conductor, the first coil conductor, and the second coil conductor can be made smaller than the largest pore diameter of the third coil conductors (i.e., the coil conductors other than the first and second coil conductors).

### Preparation of Multilayer Block

The coil sheets and the via sheets are layered in the lamination direction (in the length direction L) in the order illustrated in FIG. 2, and the layered sheets are subjected to thermal-pressure bonding to produce a multilayer block.

### Preparation of Multilayer Body and Coil

The multilayer block is separated into individual chips having a predetermined size using a dicing machine.

The separated chips are subsequently sintered. The sintering temperature is, for example, 900° C. or more and 920° C. or less (i.e., from 900° C. to 920° C.). The sintering duration is, for example, 2 hours or more and 4 hours or less (i.e., from 2 hours to 4 hours).

When each separated chip is sintered, the portion of the coil sheet and the portion of the via sheet, the portions being derived from the green sheet, become the insulating layer.

When each separated chip is sintered, the conductor traces for the coil conductors, the lands, and the via conductors become the coil conductors, the lands, and the via conductors, respectively. The coil is thus produced. The coil is made of the coil conductors that are laminated together with the insulating layers and electrically connected together using the via conductors. The first extended conductor and the second extended conductor are also produced as the extensions of the coil exposed at respective end surfaces of the multilayer body. Here, pores are generated in the coil conductors, the lands, and the via conductors at the pore area ratio corresponding to the composition of original conductor traces or the conductor paste.

Thus, the multilayer body in which multiple insulating layers are laminated in the lamination direction and the coil is formed inside is produced.

The multilayer body may be subjected to barrel polishing to round edges and vertices.

### Formation of Outer Electrodes

A conductive paste, such as a paste containing Ag and glass frit, is applied onto the first and second end surfaces of the multilayer body at which the extensions of the coil are exposed, thereby forming a conductive paste layer.

The conductive paste layer is sintered to form a base electrode, in other words, a base layer of the outer electrode. The sintering temperature is, for example, 800° C. or more and 820° C. or less (i.e., from 800° C. to 820° C.). The thickness of the base electrode is, for example, 5 μm.

A Ni-plating layer and a Sn-plating layer are formed on the base electrode by electrolytic plating or the like. Thus, the outer electrode is formed to have the base electrode, the Ni-plating layer, and the Sn-plating layer.

Thus, the multilayer coil component is produced.

In a method of manufacturing a multilayer coil component according to a second embodiment of the present disclosure, the multilayer coil component includes i) a multilayer body formed by laminating multiple insulating layers and having an inner electrode, and ii) a first outer electrode and a second outer electrode each of which is electrically connected to the inner electrode. The inner electrode includes i) a coil formed by laminating multiple coil conductors together with the insulating layers, the coil conductors being electrically connected together, ii) a first extended conductor connecting between the coil and the first outer electrode, and iii) a second extended conductor connecting between the coil and the second outer electrode. The first extended conductor and the second extended conductor extend in a lamination direction in which the insulating layers are laminated. The method of manufacturing the multilayer coil component includes i) a step of preparing ceramic green sheets containing a ceramic material, ii) a printing step of forming conductor paste layers by applying a conductor paste onto the ceramic green sheets, the conductor paste layers corresponding to the coil conductors, the first extended conductor, and/or the second extended conductor, iii) a step of preparing an unsintered multilayer body containing an unsintered coil by laminating the ceramic green sheets with the conductor paste layers formed thereon, and iv) a step of sintering the unsintered multilayer body to obtain a multilayer body. Among the coil conductors, a coil conductor connected directly to the first extended conductor is a first coil conductor, and a coil conductor connected directly to the second extended conductor is a second coil conductor. The conductor paste for forming the first extended conductor, the second extended conductor, the first coil conductor, and the second coil conductor contains a metal powder produced using a method other than a water atomization method, and the conductor paste for forming at least one of the coil conductors other than the first coil conductor and the second coil conductor contains a metal powder produced using the water atomization method.

The water atomization method is a method of producing a metal powder by jetting water to a molten metal. The molten metal and water come into contact with each other, which causes the metal powder to take in oxygen easily. Accordingly, when the conductor paste containing the metal powder produced by the water atomization method is sintered, more pores are formed in the conductors sintered compared with the case using a conductor paste containing a metal powder produced by a method other than the water atomization. The “method other than the water atomization” above may be a method that does not use the atomization method at all or may be a method that utilizes an atomization method other than the water atomization.

Accordingly, the conductor paste containing the metal powder produced by a method other than the water atomization is used to form the first extended conductor, the second extended conductor, the first coil conductor, and the second coil conductor, while the conductor paste containing the metal powder produced by the water atomization method is used to form at least one of the coil conductors other than the first and second coil conductors. As a result, the multilayer coil component can be obtained, of which the first extended conductor, the second extended conductor, the first coil conductor, and the second coil conductor have a pore area ratio of 1.00% or more and 11.00% or less (i.e., from 1.00% to 11.00%) and at least one of the coil conductors other than the first and second coil conductors has a pore area ratio of more than 11.00% and 20.00% or less (i.e., from more than 11.00% to 20.00%).

The method of manufacturing the multilayer coil component according to a second embodiment of the present disclosure is different from the method of manufacturing the multilayer coil component according to a first embodiment of the present disclosure in the following manner: the low-porosity conductor paste in the first embodiment, which is the conductor paste having a PVC of 45.00% or more and 55.00% or less (i.e., from 45.00% to 55.00%), is replaced with the conductor paste containing the metal powder produced by a method other than the water atomization, and the high-porosity conductor paste in the first embodiment is also replaced with the conductor paste containing the metal powder produced by the water atomization method.

Accordingly, in the method of manufacturing the multilayer coil component according to the second embodiment of the present disclosure, the high-porosity conductor paste corresponds to the conductor paste containing the metal powder produced by the water atomization method, and the low-porosity conductor paste corresponds to the conductor paste containing the metal powder produced by a method other than the water atomization.

The metal powder produced by the water atomization method is made of Ag, Au, Cu, Pd, Ni, or Al, or an alloy containing at least one of these metals, with Ag being preferred.

Examples of methods other than water atomization include methods using electrolysis, milling or grinding, chemical reduction, thermal treatment, and also include such atomization methods as gas atomization, disk atomization, and plasma atomization.

The metal powder produced by a method other than the water atomization is made of Ag, Au, Cu, Pd, Ni, or Al, or an alloy containing at least one of these metals, with Ag being preferred.

The type (i.e., chemical composition) of the metal powder produced by the water atomization method may be different from that of the metal powder produced by a method other than the water atomization. It is preferable, however, that these types of the metal powders be the same. For example, in the case of the metal powder produced by the water atomization method being an Ag powder, the metal powder produced by a method other than the water atomization is preferably the Ag powder.

The present specification discloses the following points.

Aspect (1) is a multilayer coil component that includes a multilayer body formed by laminating multiple insulating layers and having an inner electrode; and a first outer electrode and a second outer electrode each of which is electrically connected to the inner electrode. The inner electrode includes a coil formed by laminating multiple coil conductors together with the insulating layers, the coil conductors being electrically connected together, a first extended conductor connecting between the coil and the first outer electrode, and a second extended conductor connecting between the coil and the second outer electrode. The first extended conductor and the second extended conductor extend in a lamination direction in which the insulating layers are laminated. Among the coil conductors, a coil conductor connected directly to the first extended conductor is a first coil conductor, and a coil conductor connected directly to the second extended conductor is a second coil conductor. Also, a pore area ratio of each of the first extended conductor, the second extended conductor, the first coil conductor, and the second coil conductor is 1.00% or more and 11.00% or less (i.e., from 1.00% to 11.00%).

Aspect (2) is the multilayer coil component according to Aspect (1), wherein a pore area ratio of at least one of the coil conductors other than the first coil conductor and the second coil conductor exceeds 11.00% and does not exceed 20.00% (i.e., from more than 11.00% to 20.00%).

Aspect (3) is the multilayer coil component according to Aspect (2), wherein a pore area ratio of all of the coil conductors except for the first coil conductor and the second coil conductor exceeds 11.00% and does not exceed 20.00% (i.e., from more than 11.00% to 20.00%).

Aspect (4) is the multilayer coil component according to any one or any combination of Aspects (1) to (3), wherein a thickness of the first coil conductor exceeds a diameter of the largest pore in the first coil conductor, and a thickness of the second coil conductor exceeds a diameter of the largest pore in the second coil conductor.

Aspect (5) is the multilayer coil component according to any one or any combination of Aspects (1) to (4), wherein a diameter of the largest pore in each of the first extended conductor, the second extended conductor, the first coil conductor, and the second coil conductor is smaller than a diameter of the largest pore in the coil conductors other than the first coil conductor and the second coil conductor.

Aspect (6) is the multilayer coil component according to any one or any combination of Aspects (1) to (5) above, wherein the insulating layers contain ferrite, and a pore area ratio of the insulating layers is 0.10% or more and 5.00% or less (i.e., from 0.10% to 5.00%).

Aspect (7) is the multilayer coil component according to any one or any combination of Aspects (1) to (5), wherein the pore area ratio of each of the first extended conductor, the second extended conductor, the first coil conductor, and the second coil conductor is 1.00% or more and 4.00% or less (i.e., from 1.00% to 4.00%).

Aspect (8) is a method of manufacturing a multilayer coil component, the multilayer coil component including a multilayer body formed by laminating multiple insulating layers and having an inner electrode and a first outer electrode and a second outer electrode each of which is electrically connected to the inner electrode. The inner electrode includes a coil formed by laminating multiple coil conductors together with the insulating layers, the coil conductors being electrically connected together, a first extended conductor connecting between the coil and the first outer electrode, and a second extended conductor connecting between the coil and the second outer electrode. The first extended conductor and the second extended conductor extend in a lamination direction in which the insulating layers are laminated. The method includes a step of preparing ceramic green sheets containing a ceramic material; a printing step of forming conductor paste layers by applying a conductor paste onto the ceramic green sheets, the conductor paste layers corresponding to the coil conductors, the first extended conductor, and/or the second extended conductor; a step of preparing an unsintered multilayer body containing an unsintered coil by laminating the ceramic green sheets with the conductor paste layers formed thereon; and a step of sintering the unsintered multilayer body to obtain a multilayer body. Among the coil conductors, a coil conductor connected directly to the first extended conductor is a first coil conductor, and a coil conductor connected directly to the second extended conductor is a second coil conductor. Also, a PVC of the conductor paste for forming the first extended conductor, the second extended conductor, the first coil conductor, and the second coil conductor is 45.00% or more and 55.00% or less (i.e., from 45.00% to 55.00%).

Aspect (9) is the method of manufacturing the multilayer coil component according to Aspect (8), wherein the PVC of the conductor paste for forming at least one of the coil conductors other than the first coil conductor and the second coil conductor is 30.00% or more and 40.00% or less (i.e., from 30.00% to 40.00%).

Aspect (10) is the method of manufacturing the multilayer coil component according to Aspect (9), wherein the PVC of the conductor paste for forming all of the coil conductors except for the first coil conductor and the second coil conductor is 30.00% or more and 40.00% or less (i.e., from 30.00% to 40.00%).

Aspect (11) is a method of manufacturing a multilayer coil component, the multilayer coil component including a multilayer body formed by laminating multiple insulating layers and having an inner electrode, and a first outer electrode and a second outer electrode each of which is electrically connected to the inner electrode. The inner electrode includes a coil formed by laminating multiple coil conductors together with the insulating layers, the coil conductors being electrically connected together, a first extended conductor connecting between the coil and the first outer electrode, and a second extended conductor connecting between the coil and the second outer electrode. The first extended conductor and the second extended conductor extend in a lamination direction in which the insulating layers are laminated. The method includes a step of preparing ceramic green sheets containing a ceramic material; a printing step of forming conductor paste layers by applying a conductor paste onto the ceramic green sheets, the conductor paste layers corresponding to the coil conductors, the first extended conductor, and/or the second extended conductor; a step of preparing an unsintered multilayer body containing an unsintered coil by laminating the ceramic green sheets with the conductor paste layers formed thereon; and a step of sintering the unsintered multilayer body to obtain a multilayer body. Among the coil conductors, a coil conductor connected directly to the first extended conductor is a first coil conductor, and a coil conductor connected directly to the second extended conductor is a second coil conductor. The conductor paste for forming the first extended conductor, the second extended conductor, the first coil conductor, and the second coil conductor contains a metal powder produced using a method other than a water atomization method. Also, the conductor paste for forming at least one of the coil conductors other than the first coil conductor and the second coil conductor contains a metal powder produced using the water atomization method.

### EXAMPLES

Examples are provided below to disclose the present disclosure more specifically. Note that the examples are not intended to limit the present disclosure.

### Preparation of Samples 1 to Samples 6

In accordance with the method of manufacturing the multilayer coil component according to the first embodiment of the present disclosure, Samples 1 to Samples 6 were prepared. Each group of samples consists of one hundred multilayer coil components. In each sample, as indicated in Table 1, the first extended conductor, the second extended conductor, the first coil conductor, and the second coil conductor were formed using the low-porosity conductor paste, while the coil conductors (i.e., the third coil conductors) other than the first coil conductor and the second coil conductor were formed using the high-porosity conductor paste. The composition (PVC) of the conductor paste (i.e., the composition of the low-porosity conductor paste and the composition of the high-porosity conductor paste) was changed for Samples 1 to Samples 6. The PVCs for the low-porosity conductor paste and the high-porosity conductor paste used in producing Samples 1 to Samples 6 are listed in Table 1.

### Determination of Wire Breakage

Electric characteristics (direct-current resistance) were measured to determine the occurrence of wire breakage for all of the one hundred samples for each group of Samples 1 to Samples 6, and the number of samples in which the wire breakage occurred were counted. Results are collated in Table 1.

### Measurement of Pore Area Ratio and Largest Pore Diameter

From an SEM image of a cross section of each sample, the pore area ratio and the largest pore diameter were determined for the first extended conductor, the second extended conductor, the first coil conductor, and the second coil conductor. In addition, an average pore area ratio and the largest pore diameter were also determined for all the coil conductors except for the first and second coil conductors. The results of one hundred samples were averaged. Results are collated in Table 1.

TABLE 1

| | | | | | | | | | | | | | | | | Ratio [%] of | | The number |
|---|---|---|---|---|---|---|---|---|---|---|---|---|---|---|---|---|---|---|
| | PVC [%] of | | | | | | | | | | | | | | | largest pore | | of samples |
| | conductor paste | | Pore area ratio [%] | | | | | Largest pore diameter [μm] | | | | | | | | diameter to | | of wire- |
| | Low- | High- | Extended | | | | | Extended | | | | | Thickness [μm] | | | thickness of | | breakage |
| | porosity | porosity | conductor | | Coil conductor | | | conductor | | Coil Conductor | | | of coil conductor | | | coil conductor | | [of 100 |
| Sample | paste | paste | 1st | 2nd | 1st | 2nd | 3rd | 1st | 2nd | 1st | 2nd | 3rd | 1st | 2nd | 3rd | 1st | 2nd | samples] |

| | | | | | | | | | |
|---|---|---|---|---|---|---|---|---|---|
| 1 | 55.00 | 40.00 | 3.50 | 12.91 | 3.3 | 26.2 | 20.0 | 16.5 | 0 |
| 2 | 52.00 | 32.00 | 6.32 | 16.74 | 8.5 | 29.1 | 20.0 | 42.5 | 0 |
| 3 | 48.00 | 30.00 | 8.56 | 17.47 | 15.6 | 31.1 | 20.0 | 78.0 | 0 |
| 4 | 45.00 | 38.00 | 9.95 | 13.64 | 19.1 | 27.1 | 20.0 | 95.5 | 0 |
| 5 | 40.00 | 35.00 | 12.90 | 15.53 | 25.9 | 28.0 | 20.0 | 129.5 | 1 |
| 6 | 30.00 | 30.00 | 17.08 | 17.49 | 30.0 | 31.0 | 20.0 | 150.0 | 8 |

As can be seen in Table 1, in each group of Samples 1 to Samples 6, the pore area ratio of the first extended conductor, the second extended conductor, the first coil conductor, and the second coil conductor took the same value. In each group of Samples 1 to Samples 6, the largest pore diameter of the first extended conductor, the second extended conductor, the first coil conductor, and the second coil conductor also took the same value.

The results in Table 1 confirms that the pore area ratio of the conductors obtained is 1.00% or more and 11.00% or less (i.e., from 1.00% to 11.00%) when the PVC of the conductor paste is set to be 45.00% or more and 55.00% or less (i.e., from 45.00% to 55.00%).

The results in Table 1 also confirms that the pore area ratio obtained is 11.00% or more and 20.00% or less (i.e., from 11.00% to 20.00%) when the PVC of the conductor paste is set to be 30.00% or more and 40.00% or less (i.e., from 30.00% to 40.00%).

It was confirmed that no wire breakage occurred for Samples 1 to Samples 4 of which the pore area ratio of the first extended conductor, the second extended conductor, the first coil conductor, and the second coil conductor was 1.00% or more and 11.00% or less (i.e., from 1.00% to 11.00%). On the other hand, it was confirmed that there is a likelihood of the wire breakage occurring in the vicinity of the connection portion (the bent portion) between the first extended conductor and the coil conductor and/or between the second extended conductor and the coil conductor in Samples 5 and Samples 6 of which the pore area ratio of the first extended conductor, the second extended conductor, the first coil conductor, and the second coil conductor exceeds 11.00%. It was also confirmed that pores were concentrated in the connection portion between the first extended conductor and the first coil conductor or the second extended conductor and the second coil conductor for those of Samples 5 and 6 in which the wire breakage occurred.

On the basis of the above results, the multilayer coil component of the present disclosure is confirmed to reduce the risk of wire breakage in the extended-conductor connection portion.

Regarding Samples 1 where the pore area ratio of the first extended conductor, the second extended conductor, the first coil conductor, and the second coil conductor was 4.00% or less, the largest pore diameter was approximately 3.3 μm, which is likely to reduce current crowding and thereby ensure electrical continuity while providing the benefit of the risk reduction of wire breakage.

What is claimed is:

1. A multilayer coil component comprising:
a multilayer body including multiple insulating layers laminated together, and having an inner electrode; and
a first outer electrode and a second outer electrode each of which is electrically connected to the inner electrode, wherein
the inner electrode includes
a coil including multiple coil conductors laminated together with the insulating layers, the coil conductors being electrically connected together,
a first extended conductor connecting between the coil and the first outer electrode, and
a second extended conductor connecting between the coil and the second outer electrode,
the first extended conductor and the second extended conductor extend in a lamination direction in which the insulating layers are laminated,
among the coil conductors, a coil conductor connected directly to the first extended conductor is a first coil conductor, and a coil conductor connected directly to the second extended conductor is a second coil conductor, and
a pore area ratio of each of the first extended conductor, the second extended conductor, the first coil conductor, and the second coil conductor is from 1.00% to 11.00%.

2. The multilayer coil component according to claim 1, wherein
a pore area ratio of at least one of the coil conductors other than the first coil conductor and the second coil conductor is from more than 11.00% to 20.00%.

3. The multilayer coil component according to claim 2, wherein
a pore area ratio of all of the coil conductors except for the first coil conductor and the second coil conductor is from more than 11.00% to 20.00%.

4. The multilayer coil component according to claim 1, wherein
a thickness of the first coil conductor exceeds a diameter of the largest pore in the first coil conductor, and
a thickness of the second coil conductor exceeds a diameter of the largest pore in the second coil conductor.

5. The multilayer coil component according to claim 1, wherein
a diameter of the largest pore in each of the first extended conductor, the second extended conductor, the first coil conductor, and the second coil conductor is smaller than a diameter of the largest pore in the coil conductors other than the first coil conductor and the second coil conductor.

6. The multilayer coil component according to claim 1, wherein
the insulating layers include ferrite, and
a pore area ratio of the insulating layers is from 0.10% to 5.00%.

7. The multilayer coil component according to claim 1, wherein
the pore area ratio of each of the first extended conductor, the second extended conductor, the first coil conductor, and the second coil conductor is from 1.00% to 4.00%.

8. The multilayer coil component according to claim 2, wherein
a thickness of the first coil conductor exceeds a diameter of the largest pore in the first coil conductor, and
a thickness of the second coil conductor exceeds a diameter of the largest pore in the second coil conductor.

9. The multilayer coil component according to claim 2, wherein
a diameter of the largest pore in each of the first extended conductor, the second extended conductor, the first coil conductor, and the second coil conductor is smaller than a diameter of the largest pore in the coil conductors other than the first coil conductor and the second coil conductor.

10. The multilayer coil component according to claim 2, wherein
the insulating layers include ferrite, and
a pore area ratio of the insulating layers is from 0.10% to 5.00%.

11. The multilayer coil component according to claim 2, wherein
the pore area ratio of each of the first extended conductor, the second extended conductor, the first coil conductor, and the second coil conductor is from 1.00% to 4.00%.

12. A method of manufacturing a multilayer coil component,
the multilayer coil component including
a multilayer body including multiple insulating layers laminated together, and having an inner electrode, and
a first outer electrode and a second outer electrode each of which is electrically connected to the inner electrode,
the inner electrode including
a coil including multiple coil conductors laminated together with the insulating layers, the coil conductors being electrically connected together,
a first extended conductor connecting between the coil and the first outer electrode, and
a second extended conductor connecting between the coil and the second outer electrode,
the first extended conductor and the second extended conductor extending in a lamination direction in which the insulating layers are laminated,
the method comprising:
preparing ceramic green sheets including a ceramic material;
forming conductor paste layers by applying a conductor paste onto the ceramic green sheets, the conductor paste layers corresponding to at least one of: the coil conductors, the first extended conductor, or the second extended conductor;
preparing an unsintered multilayer body including an unsintered coil by laminating the ceramic green sheets with the conductor paste layers formed thereon; and
sintering the unsintered multilayer body to obtain a multilayer body, wherein
among the coil conductors, a coil conductor connected directly to the first extended conductor is a first coil conductor, and a coil conductor connected directly to the second extended conductor is a second coil conductor, and
a PVC of the conductor paste for forming the first extended conductor, the second extended conductor, the first coil conductor, and the second coil conductor is from 45.00% to 55.00%.

13. The method of manufacturing the multilayer coil component according to claim 12, wherein
the PVC of the conductor paste for forming at least one of the coil conductors other than the first coil conductor and the second coil conductor is from 30.00% to 40.00%.

14. The method of manufacturing the multilayer coil component according to claim 13, wherein
the PVC of the conductor paste for forming all of the coil conductors except for the first coil conductor and the second coil conductor is from 30.00% to 40.00%.

15. A method of manufacturing a multilayer coil component,
the multilayer coil component including
a multilayer body including multiple insulating layers laminated together, and having an inner electrode, and
a first outer electrode and a second outer electrode each of which is electrically connected to the inner electrode,
the inner electrode including
a coil including multiple coil conductors laminated together with the insulating layers, the coil conductors being electrically connected together,
a first extended conductor connecting between the coil and the first outer electrode, and
a second extended conductor connecting between the coil and the second outer electrode,
the first extended conductor and the second extended conductor extending in a lamination direction in which the insulating layers are laminated,
the method comprising:
preparing ceramic green sheets including a ceramic material;
forming conductor paste layers by applying a conductor paste onto the ceramic green sheets, the conductor paste layers corresponding to at least one of: the coil conductors, the first extended conductor, or the second extended conductor;
preparing an unsintered multilayer body including an unsintered coil by laminating the ceramic green sheets with the conductor paste layers formed thereon; and
sintering the unsintered multilayer body to obtain a multilayer body, wherein
among the coil conductors, a coil conductor connected directly to the first extended conductor is a first coil conductor, and a coil conductor connected directly to the second extended conductor is a second coil conductor, and
the conductor paste for forming the first extended conductor, the second extended conductor, the first coil conductor, and the second coil conductor includes a metal powder produced using a method other than a water atomization method, and
the conductor paste for forming at least one of the coil conductors other than the first coil conductor and the second coil conductor includes a metal powder produced using the water atomization method.
